(19) United States
(12) Patent Application Publication
(10) Pub. No.: US 2018/0164530 A1
(43) Pub. Date: Jun. 14, 2018

(54) Lens Module

(71) Applicant: Chuandong Wei, Shenzhen (CN)

(72) Inventor: Chuandong Wei, Shenzhen (CN)

(73) Assignee: AAC Technologies Pte. Ltd., Singapore city (SG)

(21) Appl. No.: 15/415,945

(22) Filed: Jan. 26, 2017

(30) Foreign Application Priority Data
Dec. 10, 2016 (CN) 201611134191.6
Dec. 10, 2016 (CN) 201621353306.6

(51) Int. Cl. G02B 7/02

(52) U.S. Cl. CPC G02B 7/021

(57) ABSTRACT

The present disclosure provides a lens module. The lens module includes a lens barrel, the lens barrel includes at least two housings which are assembled to form accommodating space and a light aperture, the housing includes an outer surface, a sectional surface, an inclined surface, and a top surface, the sectional surfaces of adjacent two housings are respectively provided with a boss and a groove which are fitted with each other, the two adjacent housings are fixed by gluing. The lens module provided by the present disclosure can bring flexibility to the assembling manner of the lens group and, moreover, can facilitate performing light extinction process on the inner wall of the lens barrel, thereby is advantageous to eliminate starry light.

### TECHNICAL FIELD

The present disclosure relates to a lens module and, in particular, to a lens module having a new lens barrel structure.

### BACKGROUND

With the development of technologies, the electronic devices have been developed to be smarter, in addition to digital cameras, portable electronic devices such as tablet PC and cellphone have been provided with a lens module. In order to meet the requirements on use, higher requirements on the image of object photographed by the lens module are proposed. However, the photographed image quality is mostly relevant to stray light generated by reflection.

In the related art, a lens module includes a barrel having accommodating space, an imaging unit accommodated in the accommodating space, the imaging unit includes a plurality of lenses. When assembling the lens module of the related art, the lenses are installed into the lens barrel in a pressing manner, the mold structure of the lens barrel is too simple, and the assembling manner is too simple either. Moreover, light extinction is difficult to be achieved on the inner wall of the lens barrel in the related art, and since the mold drawing direction of an integrated lens barrel is parallel to the optical axis, the inner wall is easily damaged during the mold drawing process.

Therefore, there is a necessity to provide a new lens module.

### BRIEF DESCRIPTION OF DRAWINGS

Many aspects of the exemplary embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a perspective view of a lens module in accordance with Embodiment 1 of the present disclosure;

FIG. 2 is a sectional view of the lens module shown in FIG. 1;

FIG. 3 is a structural view of a first housing in the lens module shown in FIG. 1;

FIG. 4 is a structural view of a second housing in the lens module shown in FIG. 1;

FIG. 5 is a top view of a lens module in accordance with Embodiment 2 of the present disclosure;

FIG. 6 is a sectional view of the lens module shown in FIG. 5;

FIG. 7 is a structural view of a first housing in the lens module shown in FIG. 5; and

FIG. 8 is a structural view of a second housing in the lens module shown in FIG. 5.

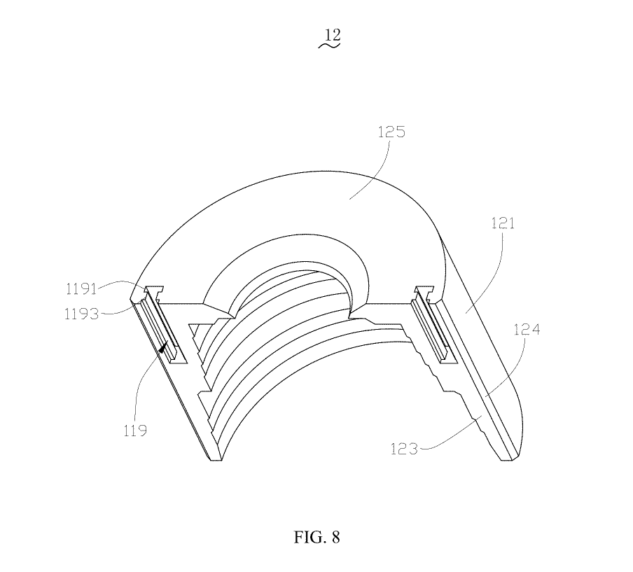

### DESCRIPTION OF EMBODIMENTS

The technical solutions in the embodiments of the present disclosure will be described clearly and completely combining the drawings in the embodiments of the present disclosure. Obviously, the described embodiments are only part of the embodiments, rather than all of them. Based on the embodiments of the present disclosure, any other embodiments obtained by those of ordinary skill in the art shall fall in the protection scope of the present disclosure.

### Embodiment 1

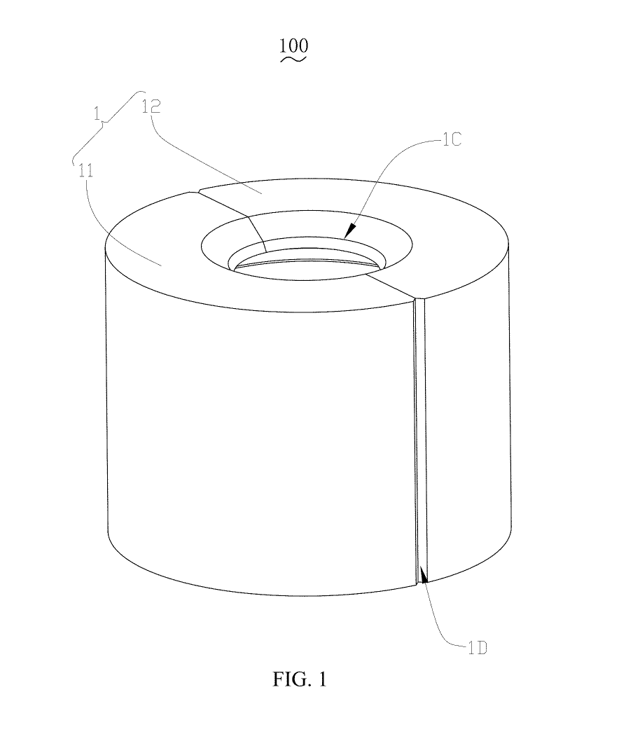

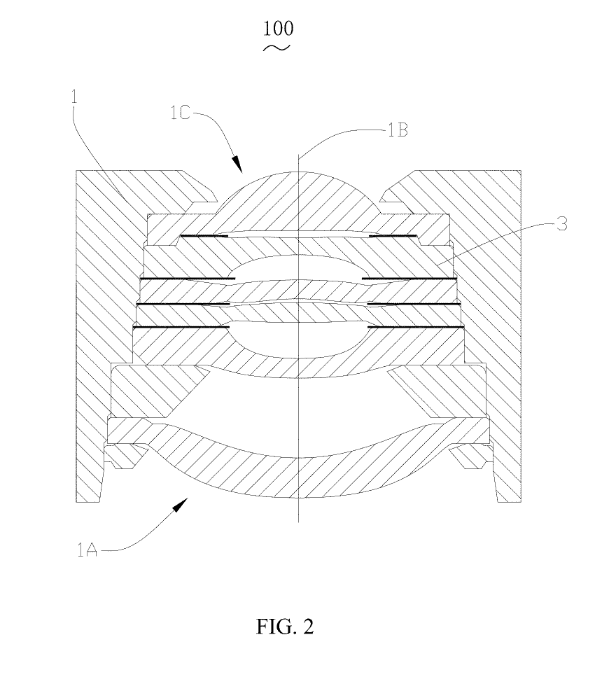

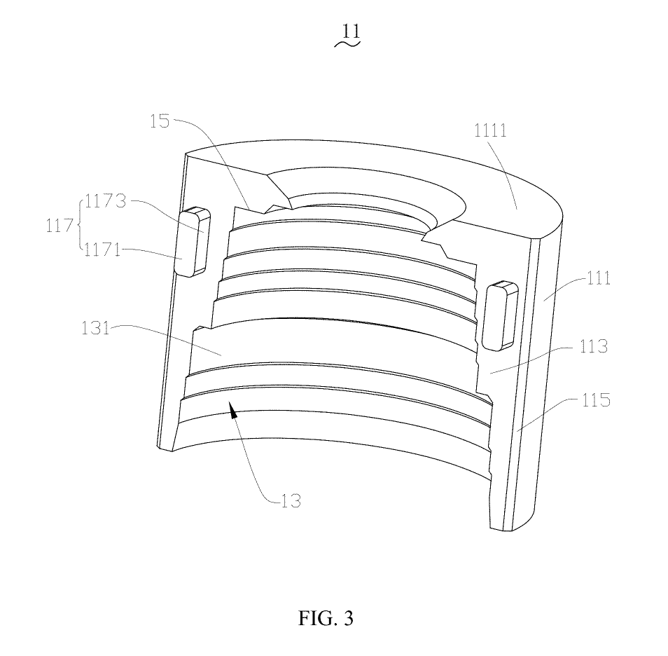

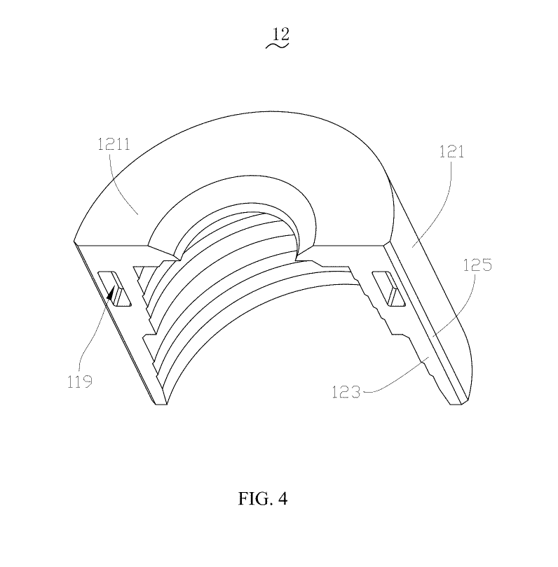

Please refer to FIGS. 1-4, the lens module 100 includes a lens barrel 1 having accommodating space 1A and a light aperture 1C formed by defining around an optical axis 1B, and a lens group 3 accommodated in the lens barrel 1.

The lens barrel 1 includes at least two housings which are assembled to form the accommodating space 1A and the light aperture 1C, the housing includes an outer surface extending along a direction from an object side to an image side, a sectional surface incorporated with an adjacent housing, an inclined surface connecting the outer surface with the sectional surface, and a top surface connecting the outer surface with the sectional surface and close to the object side. In Embodiment 1, the number of the housing is two, which is a first housing 11 and a second housing 12, respectively. The sectional surface where the first housing 11 and the second housing 12 are fitted divides the lens barrel 1 into two symmetrical portions. The outer surface, sectional surface, inclined surface and top surface of the first housing 11 are respectively a first outer surface 111, a first sectional surface 113, a first inclined surface 115 and a first top surface 1111; the outer surface, sectional surface, inclined surface and top surface of the second housing 12 are respectively a second outer surface 121, a second sectional surface 123, a second inclined surface 125 and a second top surface 1211.

Both the first outer surface 111 and the second outer surface 121 are arc surfaces, both the first inclined surface 115 and the second inclined surface 125 can be flat surfaces or curved surfaces. After the first housing 11 is assembled with the second housing 12, the first outer surface 111 and the second outer surface 121 form a cylinder outer surface of the lens barrel 1, the first inclined surface 115 and the second inclined surface 125 form a glue dispensing groove 1D. The first housing 11 and the second housing 12 are fixed by gluing, the glue dispensing groove 1D is used for glue dispensing so as to fix the first housing 11 and the second housing 12. In Embodiment 1, the first inclined surface 115 and the second inclined surface 125 are both flat surfaces. The two adjacent housings can also be fixed through applying glue on the sectional surface, a boss and in the groove.

The first sectional surface 113 and the second sectional surface 123 are respectively provided with a boss 117 and a groove 119 which fits with each other, the groove 119 does not penetrate through the second top surface 1211, the boss 117 and the groove 119 are configured to fittedly fix and connect the first housing 11 with the second housing 12.

When assembling, the boss 117 is inserted into the groove 119 along a direction perpendicular to the first sectional surface 113 and the second sectional surface 123. As shown in the figures, the first sectional surface 113 is provided with the boss 117, the second sectional surface is provided with the groove 119, but the present embodiment does not limit the specific number of the boss 117 and the groove 119.

The boss 117 and the first sectional surface 113 can be separated or integrated as a whole.

The boss 117 includes an end surface 1171 which is parallel to and spaced from the first sectional surface 113, and a side surface 1173 which connects the end surface 1171 with the first sectional surface 113 and is perpendicular to the first sectional surface 113 and the end surface 1171. Optionally, the end surface 1171 is of a track shape.

Both the first housing 11 and the second housing 12 can further include a first inner surface 13 extending along a direction from the object side to the image side, and a second inner surface 15 extending along a direction from a periphery of the first inner surface 13 close to the object side towards the optical axis 1B, the first inner surface 13 and the second inner surface 15 are both inner surfaces after being performed with light extinction process.

The first inner surface 13 includes a plurality of arc surfaces 131 which present a stepped distribution, and a radius of the arc surface close to the object side is smaller than that of the arc surface close to the image side.

The arc surfaces 131 corresponding to the first housing 11 and the second housing 12 are assembled to form a cylinder surface.

The beneficial effect of the lens module provided by Embodiment 1 lies in: through providing the lens barrel by assembling at least two housings, and the housing includes an outer surface extending along a direction from an object side to an image side, a sectional surface for fitting with an adjacent housing, an inclined surface connecting the outer surface with the sectional surface, and a top surface connecting the outer surface with the sectional surface and close to the object side, sectional surfaces of two adjacent housings are provided with a boss and a groove which are fitted with each other, the inclined surfaces of two adjacent housings are assembled to form a glue dispensing groove, when assembling, the boss is inserted into the groove along a direction perpendicular to the sectional surface, which solves the problem that the lens barrel has a too simple mold structure, meanwhile makes the assembling manner and mold design more flexible, which is advantageous to perform light extinction process to the inner wall of the lens barrel, moreover, since the separated structure has a mold drawing direction perpendicular to the optical axis, thereby avoiding the problem that the inner wall is easily damaged during the mold drawing process due to the fact that the mold drawing direction of an integrated lens barrel is parallel to the optical axis in the conventional integrated lens barrel.

### Embodiment 2

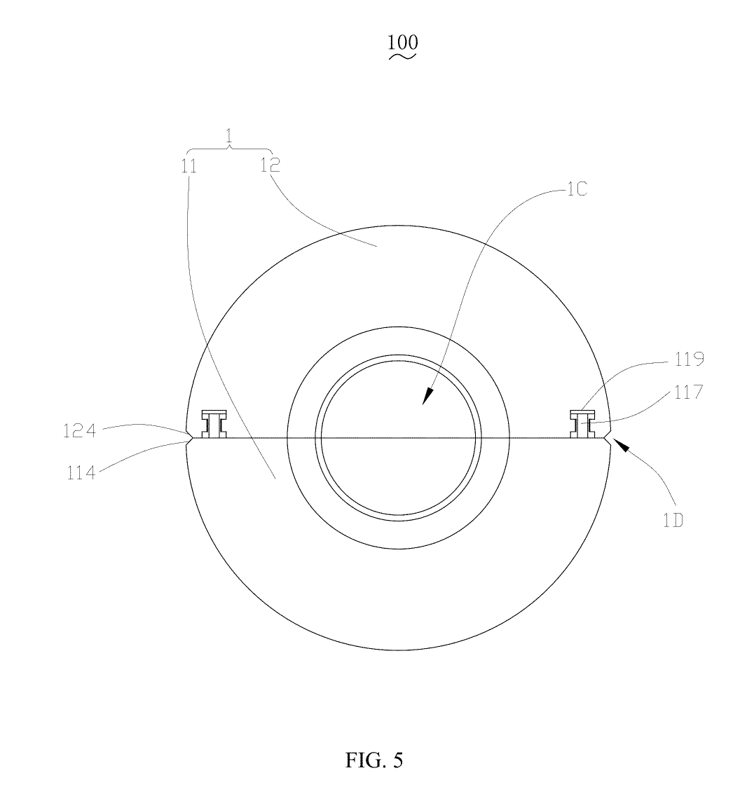

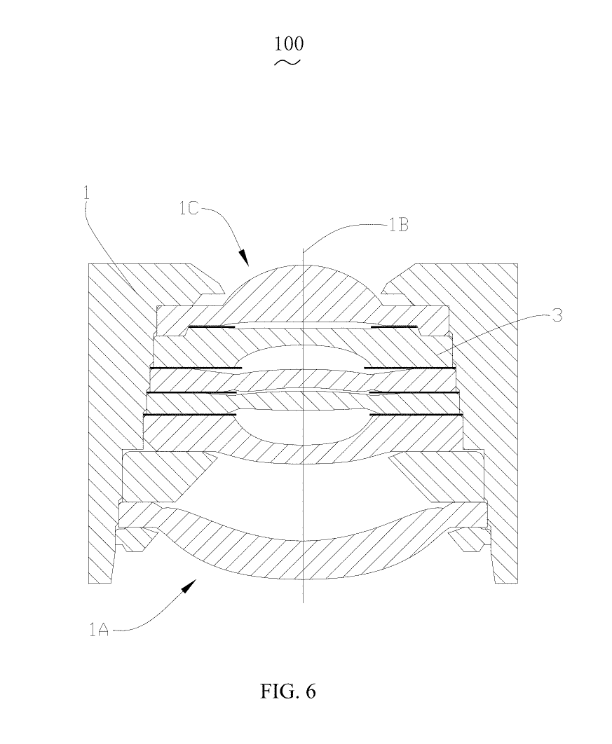

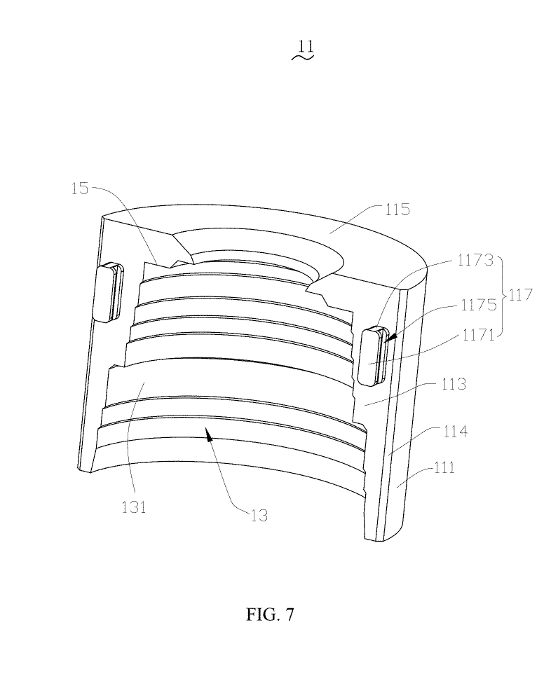

Please refer to FIGS. 5-7, the lens module 100 includes a lens barrel 1 having accommodating space 1A and a light aperture 1C formed by defining around an optical axis 1B, and a lens group 3 accommodated in the lens barrel 1.

The lens barrel 1 includes at least two housings which are assembled to form the accommodating space 1A and the light aperture 1C, the housing includes an outer surface extending along a direction from an object side to an image side, a sectional surface for fitting with an adjacent housing, an inclined surface connecting the outer surface with the sectional surface, and a top surface connecting the outer surface with the sectional surface and close to the object side. In Embodiment 2, optionally, the number of the housing is two, which is a first housing 11 and a second housing 12, respectively. The sectional surface where the first housing 11 and the second housing 12 are fitted divides the lens barrel 1 into two symmetrical portions. The outer surface, sectional surface, inclined surface and top surface of the first housing 11 are respectively a first outer surface 111, a first sectional surface 113, a first inclined surface 114 and a first top surface 115; the outer surface, sectional surface, inclined surface and top surface of the second housing 12 are respectively a second outer surface 121, a second sectional surface 123, a second inclined surface 124 and a second top surface 125.

Both the first outer surface 111 and the second outer surface 121 are arc surfaces, both the first inclined surface 114 and the second inclined surface 124 can be flat surfaces or curved surfaces. After the first housing 11 is assembled with the second housing 12, the first outer surface 111 and the second outer surface 121 form a cylinder outer surface of the lens barrel 1, the first inclined surface 114 and the second inclined surface 124 form a glue dispensing groove 1D, the first top surface 115 and the second top surface 125 form a ring shaped top surface of the lens barrel 1. The first housing 11 and the second housing 12 are fixed by gluing, the glue dispensing groove 1D is used for glue dispensing so as to fix and connect the first housing 11 and the second housing 12. In Embodiment 2, the first inclined surface 114 and the second inclined surface 124 are both flat surfaces. The two adjacent housings can also be fixed through applying glue on the sectional surface, a boss and in the groove.

The first sectional surface 113 and the second sectional surface 123 are respectively provided with a boss 117 and a groove 119 which are fitted with each other. As shown in the figures, the first sectional surface 113 is provided with the boss 117, the second sectional surface 123 is provided with the groove 119, and the groove 119 penetrates through the second top surface 125, when assembling, the boss 117 is inserted into the groove 119 along the direction of the optical axis 1B.

The boss 117 and the groove 119 are configured to fittedly fix and connect the first housing 11 with the second housing 12. The present embodiment does not limit the specific number of the boss 117 and the groove 119.

The boss 117 and the first sectional surface 113 can be separated or integrated as a whole.

The boss 117 includes an end surface 1171 which is parallel to and spaced from the first sectional surface 113, a side surface 1173 which connects the end surface 1171 with the first sectional surface 113 and is perpendicular to the first sectional surface 113 and the end surface 1171, and a limiting groove 1175 which is formed by sinking from the side surface 1173 and is parallel to the optical axis 1B. Optionally, the end surface 1171 is of a track shape.

The groove 119 includes two side walls 1191 which are spaced from and parallel to each other and are perpendicular to the second sectional surface 123, and a positioning portion 1193 formed by protruding from the two side walls 1191 and extends along the optical axis 1B direction, the positioning portion 1193 is embedded in the limiting groove 1175, a size of the positioning portion 1193 along the optical axis 1B direction is not smaller than a size of the boss 117 along the optical axis 1B direction. In the present embodiment, the size of the positioning portion 1193 along the optical axis 1B direction is larger than the size of the boss 117 along the optical axis 1B direction.

It should be understood that, in Embodiment 2, it is also possible that the limiting groove is formed by sinking of the two side walls 1191, the positioning portion is formed by protruding of the side surface 1173; however, the boss and the groove are not limited to the structure of the boss 117 and the groove 119, other bosses and grooves are also possible as long as the boss can be inserted into the groove along the optical axis direction.

Both the first housing 11 and the second housing 12 can further include a first inner surface 13 extending along a direction from the object side to the image side, and a second inner surface 15 extending along a direction from a periphery of the first inner surface 13 close to the object side towards the optical axis 1B, the first inner surface 13 and the second inner surface 15 are both inner surfaces after being performed with light extinction process.

The first inner surface 13 includes a plurality of arc surfaces 131 which present a stepped distribution, and a radius of the arc surface 131 close to the object side is smaller than that of the arc surface 131 close to the image side.

The arc surfaces 131 corresponding to the first housing 11 and the second housing 12 are assembled to form a cylinder surface.

The beneficial effect of the lens module provided by Embodiment 2 lies in: through providing the lens barrel by assembly at least two housings, and the housing includes an outer surface extending along a direction from an object side to an image side, a sectional surface for fitting with an adjacent housing, an inclined surface connecting the outer surface with the sectional surface, and a top surface connecting the outer surface with the sectional surface and close to the object side, sectional surfaces of two adjacent housings are provided with a boss and a groove which are fitted with each other, the boss penetrates through the correspondingly arranged top surface, the inclined surfaces of two adjacent housings are assembled to form a glue dispensing groove, when assembling, the boss is inserted into the groove along the optical axis direction, which solves the problem that the lens barrel has a too simple mold structure, meanwhile makes the assembling manner and mold design more flexible, which is advantageous to perform light extinction process to the inner wall of the lens barrel, moreover, since the separated structure has a mold drawing direction perpendicular to the optical axis, thereby avoiding the problem that the inner wall is easily damaged during the mold drawing process due to the fact that the mold drawing direction of an integrated lens barrel is parallel to the optical axis in the conventional integrated lens barrel.

It should be noted that, the above are merely exemplary embodiments of the present disclosure, those skilled in the art can make improvements without departing from the inventive concept of the present disclosure, however, these improvements shall belong to the protection scope of the present disclosure.

What is claimed is:

1. A lens module, comprising:
a lens barrel having accommodating space and forming a light aperture by defining around an optical axis; and
a lens group accommodated in the lens barrel,
wherein the lens barrel comprises at least two housings which are assembled to form the accommodating space and the light aperture, the housing comprises an outer surface extending along a direction from an object side to an image side, a sectional surface for fitting with an adjacent housing, an inclined surface connecting the outer surface with the sectional surface, and a top surface connecting the outer surface with the sectional surface and close to the object side, the sectional surfaces of adjacent two housings are respectively provided with a boss and a groove which are fitted with each other, the two adjacent housings are fixed by gluing.

2. The lens module as described in claim 1, wherein the groove does not penetrate through the top surface.

3. The lens module as described in claim 2, wherein two adjacent inclined surfaces form a glue dispensing groove, the glue dispensing groove is fixed by gluing.

4. The lens module as described in claim 3, wherein the boss comprises an end surface which is parallel to and spaced from the sectional surface, and a side surface which connects the end surface with the sectional surface and is perpendicular to the sectional surface and the end surface.

5. The lens module as described in claim 4, wherein the end surface is of a track shape.

6. The lens module as described in claim 3, wherein the inclined surface is a flat surface or a curved surface.

7. The lens module as described in claim 2, wherein the sectional surface and the boss arranged thereon form an integrated structure.

8. The lens module as described in claim 2, wherein the sectional surface and the boss arranged thereon form a separated structure.

9. The lens module as described in claim 2, there are two housings, a sectional surface where the two housings are fitted divides the lens barrel into two symmetrical portions.

10. The lens module as described in claim 1, wherein the groove penetrates through the top surface.

11. The lens module as described in claim 10, wherein two adjacent inclined surfaces form a glue dispensing groove, the glue dispensing groove is fixed by gluing.

12. The lens module as described in claim 11, wherein the boss includes an end surface which is parallel to and spaced from the sectional surface, a side surface which connects the end surface with the sectional surface and is perpendicular to the sectional surface and the end surface, and a limiting groove formed by sinking from the side surface and is parallel to the optical axis, the groove comprises two side walls which are spaced from and parallel to each other and are perpendicular to the sectional surface, and a positioning portion formed by protruding from the two side walls and extending along the optical axis direction, the positioning portion is embedded in the limiting groove.

13. The lens module as described in claim 12, wherein a size of the positioning portion along the optical axis direction is not smaller than a size of the boss along the optical axis direction.

14. The lens module as described in claim 12, wherein the end surface is of a track shape.

15. The lens module as described in claim 11, wherein the inclined surface is a flat surface or a curved surface.

16. The lens module as described in claim 10, wherein the sectional surface and the boss arranged thereon form an integrated structure.

17. The lens module as described in claim 10, wherein the sectional surface and the boss arranged thereon form a separated structure.

18. The lens module as described in claim 10, there are two housings, a surface where the two housings are fitted divides the lens barrel into two symmetrical portions.
